(19) United States
(12) Patent Application Publication
(10) Pub. No.: US 2011/0191678 A1
(43) Pub. Date: Aug. 4, 2011

(54) INFORMATION PROCESSING APPARATUS

(75) Inventor: Satoshi KANEKO, Iruma-gun (JP)

(73) Assignee: KABUSHIKI KAISHA TOSHIBA, Tokyo (JP)

(21) Appl. No.: 12/965,679

(22) Filed: Dec. 10, 2010

(30) Foreign Application Priority Data
Jan. 29, 2010 (JP) 2010-019690

(51) Int. Cl. G06F 3/00

(52) U.S. Cl. 715/716

(57) ABSTRACT

According to one embodiment, an information processing apparatus includes: a main body casing; a display casing connected to the main body casing so as to be rotatable between a closed position at which an upper face of the main body casing is covered, and an opened position at which the upper face of the main body casing is opened; an illuminance sensor configured to detect an ambient illuminance around the main body casing; at least one button provided at the upper face of the main body casing; a user interface configured to allow the user to enter a function setting in which the ambient illuminance and a function allocated to the button are associated; and a controller configured to output, when the button is operated, a code for executing a function, based on (1) the ambient illuminance and (2) the function setting.

### CROSS-REFERENCE TO RELATED APPLICATION(S)

This application is based upon and claims the benefit of priority from Japanese Patent Application No. 2010-019690, filed on Jan. 29, 2010, the entire contents of which are incorporated herein by reference.

### FIELD

Embodiments described herein relate generally to an information processing apparatus including an illuminance sensor.

### BACKGROUND

Some kinds of information processing apparatus is designed to be portable. Notebook personal computers may be used not only in offices, but also in transport aircrafts such as airplanes and/or at hotels such as business trip destinations. For example, personal computers are used in sufficiently well-lit places in some cases, and are used in dimly-lit places in other cases such as cabins in airplanes where the light is turned off and hotel rooms where indirect lighting is used. An apparatus (such as a personal computer) to be used in different lighting environments may be provided with an illuminance sensor.

For example, JP-2009-111451-A discloses a remote control for carrying out control in accordance with an illuminance of an ambient environment. An illuminance sensor is placed in the remote control. And, when the measured illuminance is lower than a preset threshold value, the remote control operates in a limited mode where only specific key operations are allowed. When a DVD is played with dim surrounding lighting at a home theater or the like, the remote control is intended to prevent a user's operation error by enabling only a key associated with a function necessary for DVD playing while disabling other keys.

Functions executed by personal computers tend to increase year after year, but it might be difficult to simply add new keys and/or buttons for the new functions due to space limitation. Therefore, contrivances are required in order to equip personal computers with more functions.

In JP-2009-111451-A, enabling and disabling of a specific key are switched in accordance with the illuminance of an ambient environment. If not only simple disabling of a function of a specific key but also changing of a function are allowed in accordance with an ambient environment, a single key/button is allowed to have plural functions. As a result, personal computers can be equipped with more functions without adding new keys/buttons.

### BRIEF DESCRIPTION OF THE DRAWINGS

A general architecture that implements the various feature of the present invention will now be described with reference to the drawings. The drawings and the associated descriptions are provided to illustrate embodiments of the present invention and not to limit the scope of the present invention.

FIG. 1 illustrates a computer according to an embodiment.

FIG. 2 illustrates an example block configuration of the computer according to the embodiment.

FIG. 3 illustrates a function setting interface for a function button according to the embodiment.

FIG. 4 illustrates function setting examples of the function button according to the embodiment.

FIG. 5 illustrates an example function execution procedure when the function button according to the embodiment is pressed.

### DETAILED DESCRIPTION

In general, according to one embodiment, an information processing apparatus includes: a main body casing; a display casing connected to the main body casing so as to be rotatable between a closed position at which an upper face of the main body casing is covered, and an opened position at which the upper face of the main body casing is opened; an illuminance sensor configured to detect an ambient illuminance around the main body casing; at least one button provided at the upper face of the main body casing; a user interface configured to allow the user to enter a function setting in which the ambient illuminance and a function allocated to the button are associated; and a controller configured to output, when the button is operated, a code for executing a function, based on (1) the ambient illuminance and (2) the function setting.

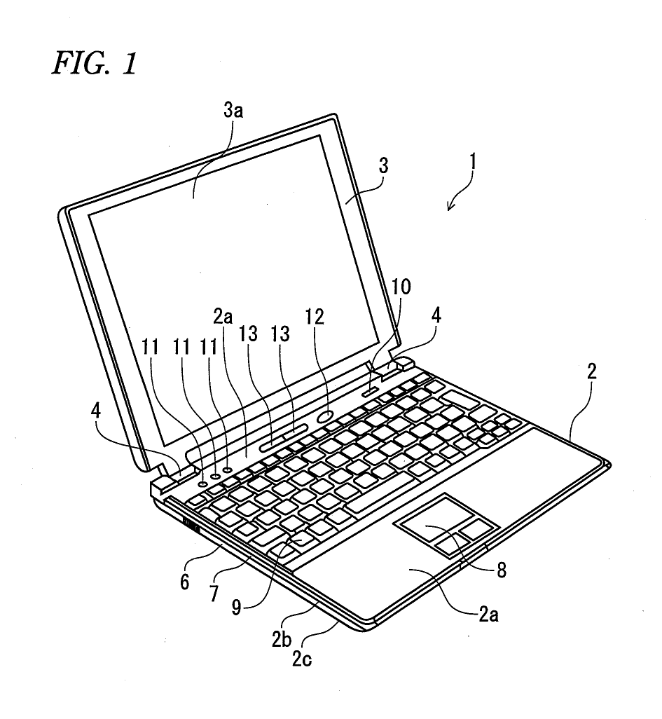

Hereinafter, an embodiment will be described with reference to the drawings. In the present embodiment, a notebook computer is exemplified as an electronic apparatus. FIG. 1 illustrates the computer according to the embodiment.

The computer 1 includes: a main body casing 2; and a display casing 3. The main body casing 2 is formed into a flat box shape having: an upper wall 2a; right and left lateral walls 2b; and a bottom wall 2c. The upper wall 2a supports a keyboard 9.

Furthermore, the main body casing 2 is divided into: a base 6 having the bottom wall 2c; and a top cover 7 having the upper wall 2a. The top cover 7 covers the base 6 from above, and is detachably supported by this base 6.

The display casing 3 is rotatably attached to the main body casing 2 via hinge parts 4. The display casing 3 is rotatable between: an opened position at which the upper wall 2a of the main body casing 2 is opened; and a closed position at which the upper wall 2a of the main body casing 2 is covered. A display device including an LCD (Liquid Crystal Display) 3a is incorporated into the display casing 3.

A touch pad 8 and the keyboard 9, through which a user performs an input operation, are attached to the upper wall 2a of the main body casing 2. Moreover, the upper wall 2a of the main body casing 2 is further provided with a power switch 10 for turning ON/OFF the power of the computer 1.

The upper wall 2a of the main body casing 2 is also provided with: LEDs 11; an illuminance sensor 12; and function buttons 13.

Each LED 11 serves as an indicator for indicating a power state of the computer 1 or a state of access to an HDD. Each LED 11 can also serve as an illumination that is lit and/or flickered, thereby decorating the computer 1 when the computer 1 is used in a dark room.

The illuminance sensor 12 measures an amount of light applied to the illuminance sensor 12 to detect an ambient illuminance therearound and to thereby detect an illuminance of an ambient environment of the computer 1. Although the illuminance sensor 12 is provided at the upper wall 2a of the main body casing 2 in an example of FIG. 1, the illuminance sensor 12 may be provided at any other position as long as the illuminance sensor 12 can detect the illuminance of the ambient environment of the computer 1.

Each function button 13 is a button for executing a function allocated thereto in advance, for example. Examples of functions allocated with the function button 13 include: a function for adjusting brightness of the LCD 3a; a function for playing a DVD; and a function for lighting/extinguishing the LED 11. Function allocated to the function button 13 can be set through a user interface. Although FIG. 1 illustrates the two function buttons 13, any number of the function buttons 13 may be provided. Furthermore, different functions may be allocated to the plural provided function buttons 13.

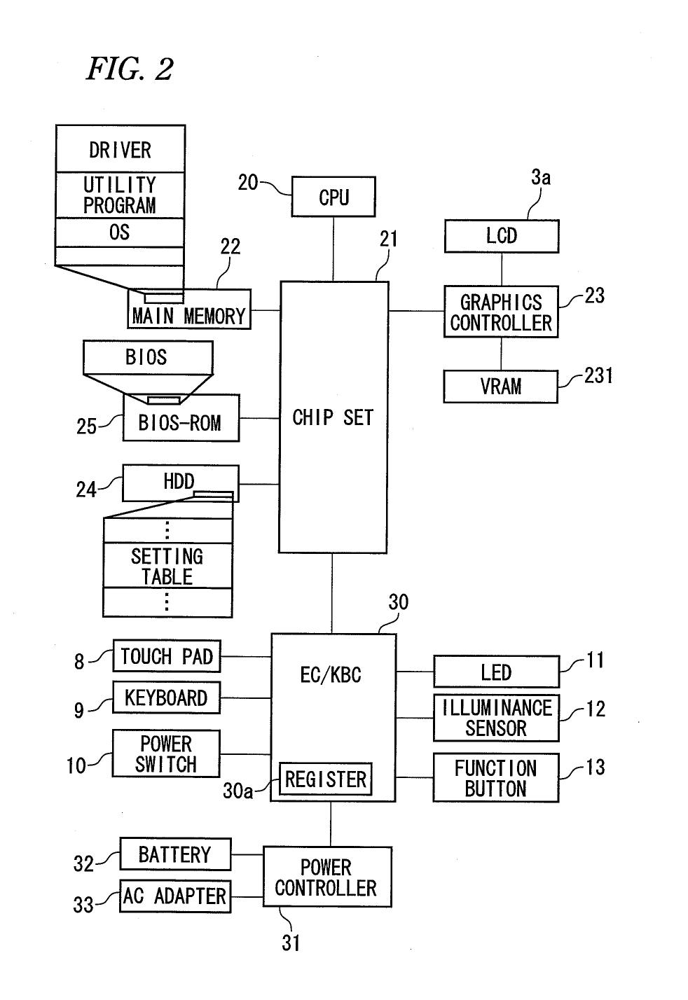

FIG. 2 illustrates an example block configuration of the computer according to the embodiment. In addition to the display device 3a, the touch pad 8, the keyboard 9, the power switch 10, the LEDs 11, the illuminance sensor 12 and the function buttons 13, the computer 1 further includes a CPU 20, a chip set 21, a main memory (RAM) 22, a graphics controller 23, a hard disk drive (HDD) 24, a BIOS-ROM 25, an embedded controller/keyboard controller IC (EC/KBC) 30, etc.

The CPU 20 is a processor for controlling an operation of each component of the computer 1. This CPU 20 executes an operating system and various application programs/utility programs, which are loaded into the main memory (RAM) 22 from the HDD 24. The main memory (RAM) 22 is also used to store various data buffers.

Furthermore, the CPU 20 also executes a BIOS (Basic Input Output System) stored in the BIOS-ROM 25. The BIOS is a program for hardware control. The BIOS includes a BIOS driver group. In order to provide plural hardware control functions to the operating system and/or application programs, each BIOS driver includes plural function execution routine groups associated with these functions.

The BIOS executes a process for expanding the operating system into the main memory (RAM) 22 from a storage device such as the HDD 24, for allowing the user to utilize the computer 1.

The chip set 21 includes: an interface with the CPU 20; an interface with the main memory (RAM) 22; and an interface with the graphics controller 23. Furthermore, the chip set 21 also communicates with the embedded controller 30.

The graphics controller 23 controls the LCD 3a used as a display monitor of the computer 1. The graphics controller sends, to the LCD 3a, a video signal corresponding to display data written into a VRAM 231 by the OS or application program.

The HDD 24 stores the OS, various application programs/utility programs, and data files. The HDD 24 also stores a setting table in which associations between the functions allocated to the function buttons 13 and illuminances are specified.

The EC/KBC (embedded controller/keyboard controller) is a single chip microcomputer on which a controller for managing the power of the computer 1, and a keyboard controller for controlling the touch pad 8, the keyboard 9, the function buttons 13, etc. are integrated.

In cooperation with a power controller 31, the EC/KBC 30 executes a process for turning ON/OFF the power of the computer 1 in response to the user's operation on the power switch 10. Using power from a battery 32 contained in the computer 1 or power supplied from outside via an AC adapter 33, the power controller 31 supplies power to the respective components inside the computer 1.

The EC/KBC 30 controls lighting and extinguishing of the LEDs 11 directly or via an unillustrated LED controller. The EC/KBC 30 includes a register 30a that stores a value of an illuminance detected by the illuminance sensor 12.

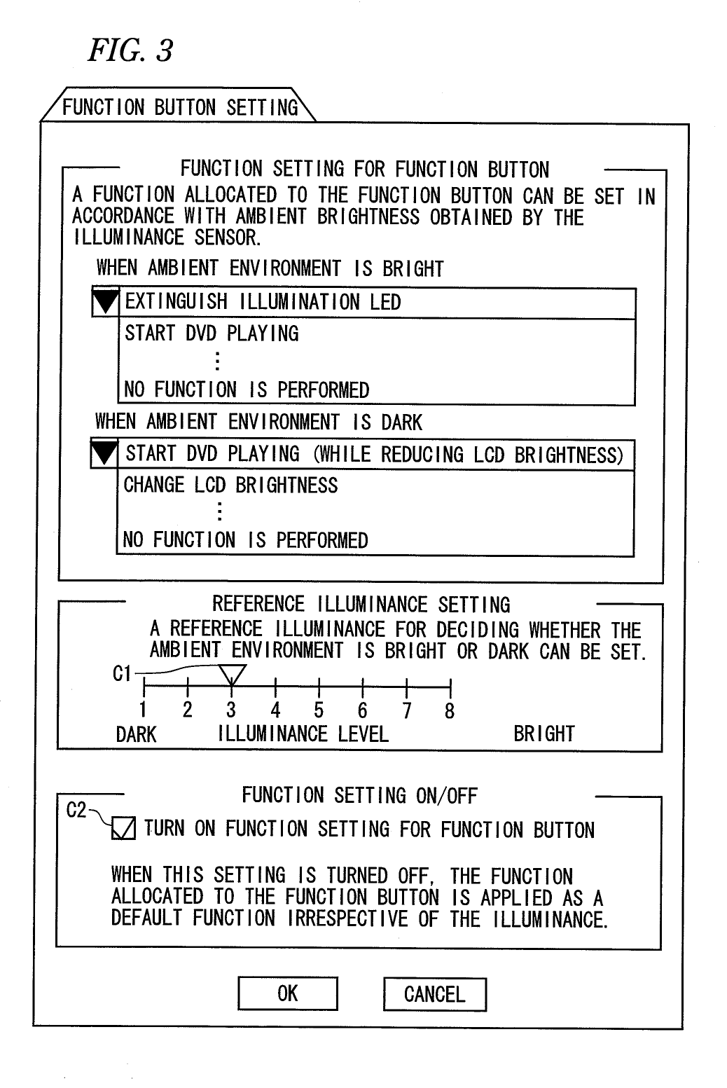

FIG. 3 illustrates a function setting interface for the function button according to the embodiment. In the present embodiment, the associations between functions allocated to the function buttons 13 and illuminances can be set by the user interface provided through a utility program.

In “Function Setting For Function Button”, a function allocated to the function button 13 can be set in accordance with ambient brightness obtained by the illuminance sensor 12. It is possible to individually set: a first function executed upon operation of the function button 13 when the ambient environment is bright; and a second function executed upon operation of the function button 13 when the ambient environment is dark. FIG. 3 illustrates a state in which settings are made so that the function of extinguishing an illumination LED is executed upon operation of the function button 13 when the ambient environment is bright, and the function of starting DVD playing (while reducing LCD brightness) is executed upon operation of the function button 13 when the ambient environment is dark.

The same function may be allocated as the first and second functions as follows. For example, DVD playing may be executed upon operation of the function button 13 when the ambient environment is bright, and DVD playing may also be executed upon operation of the function button 13 when the ambient environment is dark. Alternatively, settings can be made so that no specific function is performed even when the function button 13 is operated.

In “Reference Illuminance Setting”, an illuminance used as the reference when the ambient environment is bright and when the ambient environment is dark can be set. The reference illuminance (threshold value) can be set by moving a cursor C1, provided on a scale indicative of illuminance levels, in a user interface screen.

FIG. 3 illustrates an example in which “Illuminance Level 3” is set as the reference illuminance (threshold value). Using this illuminance level 3 as the threshold value, the following determinations are made. When the illuminance level detected by the illuminance sensor 12 is 1 to 3 (i.e., when the detected illuminance level is equal to or lower than the threshold value), the ambient environment is determined to be “dark”, and when the illuminance level detected by the illuminance sensor 12 is 4 to 8 (i.e., when the detected illuminance level is higher than the threshold value), the ambient environment is determined to be “bright”.

FIG. 3 illustrates an example in which the reference illuminance is set using eight levels of illuminances, but the reference illuminance may be set more minutely. Furthermore, whether the illuminance, by which the ambient environment is determined to be “dark” with respect to the reference illuminance level (threshold value), is defined as being “lower than the threshold value (illuminance<threshold value)” or “equal to or lower than the threshold value (illuminance≦threshold value)” may be freely set. Similarly, whether the illuminance, by which the ambient environment is determined to be “bright” with respect to the reference illuminance level (threshold value), is defined as being “equal to or higher than the threshold value (illuminance threshold value)” or “higher than the threshold value (illuminance>threshold value)” may be freely set.

In “Function Setting ON/OFF”, whether or not the function allocated to the function button 13 is changed in accordance with the illuminance can be set. The function button 13 enters a “Function Setting ON” state when a check box C2 is checked, and the function button 13 enters a “Function Setting OFF” state when the check box C2 is unchecked. In the “Function Setting ON” state, the function allocated to the function button 13 can be changed in accordance with the illuminance. As already mentioned above, for example, settings can be made so that the function of extinguishing the illumination LED is executed upon operation of the function button 13 when the ambient environment is “bright”, and the function of starting DVD playing (while reducing LCD brightness) is executed upon operation of the function button 13 when the ambient environment is “dark”. In the “Function Setting OFF” state, the function allocated to the function button 13 is not changed in accordance with the illuminance. In other words, even when the ambient environment is “bright” or “dark”, the function allocated as default to the function button 13 is applied. For example, if the function of “starting an Internet browser” is allocated to the function button 13 as default, the Internet browser is started upon operation of the function button 13 even when the ambient environment is “bright” or “dark”.

The utility program is executed as described above, thus setting the association between the function allocated to the function button 13 and the illuminance. This setting is stored as the setting table in the HDD 24.

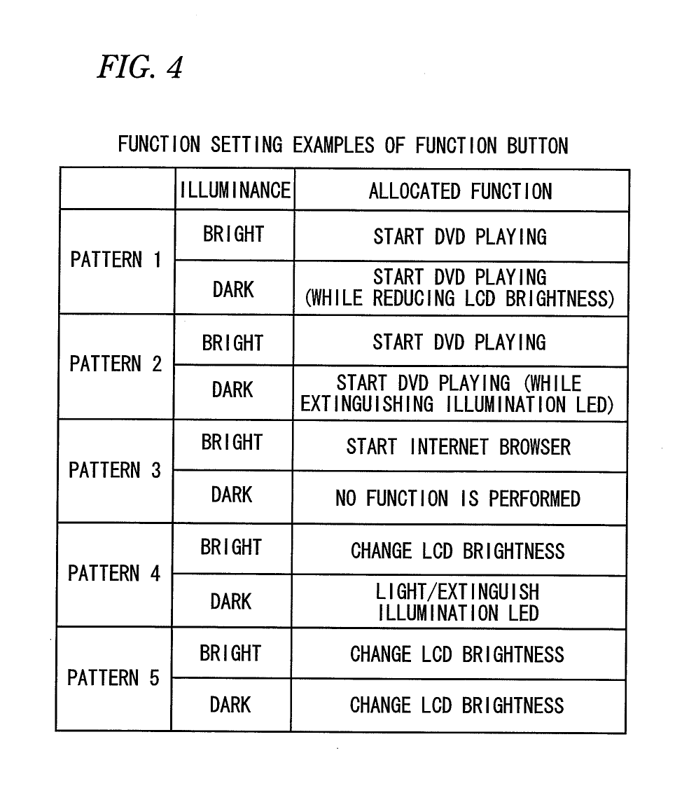

FIG. 4 illustrates function setting examples of the function button according to the embodiment. FIG. 4 illustrates Pattern 1 to Pattern 5 as the function setting examples.

In Pattern 1, the function of “starting DVD playing” is allocated to the function button 13 when the ambient environment is “bright”, and the function of “starting DVD playing (while reducing LCD brightness)” is allocated to the function button 13 when the ambient environment is “dark”. By reducing the brightness of the LCD 3a (or by changing the brightness of the LCD 3a to a lowest level) when the ambient environment is dark, glare on an image displayed through DVD playing can be reduced. Also, power consumed by the LCD 3a can be reduced.

In Pattern 2, the function of “starting DVD playing” is allocated to the function button 13 when the ambient environment is “bright”, and the function of “starting DVD playing (while extinguishing the illumination LED)” is allocated to the function button 13 when the ambient environment is “dark”. By extinguishing the illumination LED during DVD playing when the ambient environment is dark, the illumination LED can be prevented from interfering with DVD viewing. Furthermore, power consumed by the LED 11 can also be reduced.

In Pattern 3, the function of “starting an Internet Browser” is allocated to the function button 13 when the ambient environment is “bright”, and a setting is made so that “no function is performed” when the ambient environment is “dark”. When the ambient environment is “bright”, the function button 13 is used as a button for starting the Internet browser; on the other hand, when the ambient environment is “dark”, an operation unintended by a user can be prevented when the function button 13 is touched by mistake.

In Pattern 4, the function of “changing LCD brightness” is allocated to the function button 13 when the ambient environment is “bright”, and the function of “lighting/extinguishing the illumination LED” is allocated to the function button 13 when the ambient environment is “dark”. When the ambient environment is “bright”, the LCD brightness can be changed in accordance with user preferences; on the other hand, when the ambient environment is “dark”, the lighting/extinguishing of the LED 11 can be performed depending on whether a user desires the decoration provided by the illumination LED or gives higher priority to the reduction in power consumption.

In Pattern 5, the function of “changing LCD brightness” is allocated to the function button 13 when the ambient environment is “bright”, and the function of “changing LCD brightness” is allocated to the function button 13 also when the ambient environment is “dark”. Even when the ambient environment is “bright” or “dark”, the LCD brightness can be changed in accordance with user preferences.

Thus, the function performed when the function button is operated can be changed in accordance with the illuminance of the ambient environment in which the computer 1 is used. Even if the ambient environment itself is not “dark”, a user can artificially create a “dark” environment by pressing (covering) the illuminance sensor 12 with his or her finger, for example. In other words, even when the ambient environment is “bright”, the function button 13 may be used so that the function executed by the function button 13 is changed between: a case where a user operates the function button 13 normally; and a case where a user operates the function button 13 while pressing (covering) the illuminance sensor 12 with his or her finger, for example, to artificially create a “dark” environment.

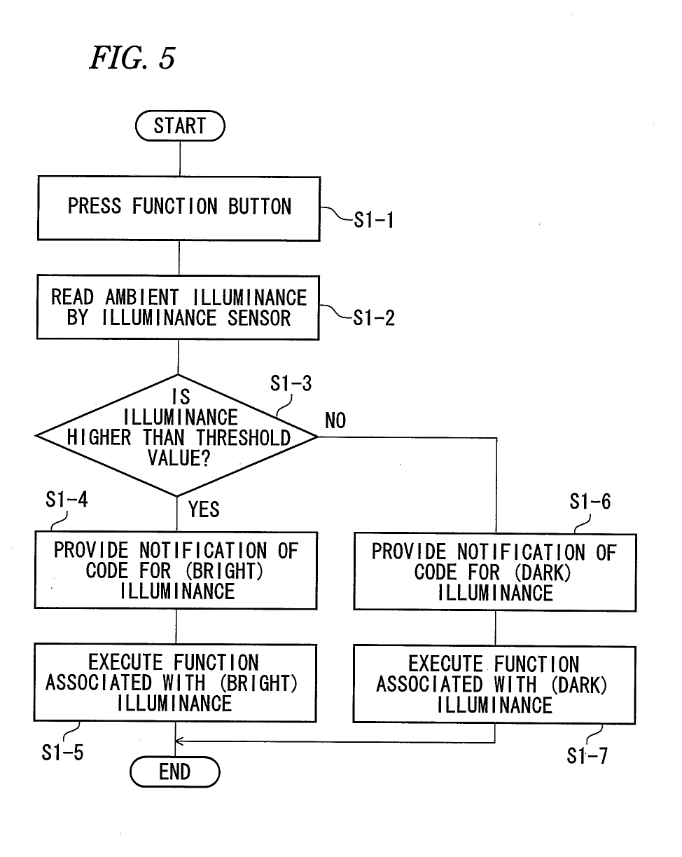

FIG. 5 illustrates an example function execution procedure when the function button according to the embodiment is pressed. An operation performed on the function button 13 is detected through the EC/KBC 30 (Step 1-1). Upon detection of the operation performed on the function button 13, the illuminance of the ambient environment of the computer 1 is detected by the illuminance sensor 12 (Step 1-2). Notification of the illuminance detected by the illuminance sensor 12 is provided to the EC/KBC 30, and the EC/KBC 30 retains the notified illuminance in the register 30a. Through the BIOS, the EC/KBC 30 provides, to the OS, notification of a code associated with the operation performed on the function button 13. Depending on whether the illuminance detected in this case is “bright” or “dark”, the EC/KBC 30 changes the type of the code, notification of which is to be provided to the BIOS and OS in response to the operation performed on the function button 13.

Upon detection of the illuminance of the ambient environment of the computer 1 by the illuminance sensor 12, the EC/KBC 30 makes a comparison between the illuminance detected by the illuminance sensor 12 and the threshold value (Step 1-3). When the detected illuminance is higher than the threshold value (when the answer is Yes in Step 1-3), the EC/KBC 30 provides notification of the code, associated with the operation performed on the function button 13 in the state where the ambient environment is “bright”, to the OS through the BIOS (Step 1-4). Then, as illustrated in FIGS. 3 and 4, the function associated with the state where the ambient environment is “bright” is executed (Step 1-5).

On the other hand, when the detected illuminance is equal to or lower than the threshold value (when the answer is No in Step 1-3), the EC/KBC 30 provides notification of the code, associated with the operation performed on the function button 13 in the state where the ambient environment is “dark”, to the OS through the BIOS (Step 1-6). Then, as illustrated in FIGS. 3 and 4, the function associated with the state where the ambient environment is “dark” is executed (Step 1-7).

The determination in Step 1-3 is made based on the following question: “Is Illuminance Higher Than Threshold Value?”, but may alternatively be made based on any of the following questions: “Is Illuminance Equal To Or Higher Than Threshold Value?”, “Is Illuminance Lower Than Threshold Value?”, and “Is Illuminance Equal To Or Lower Than Threshold Value?”. It should be noted that the following methods may be adopted as variations in executing the function corresponding to the illuminance notification and the illuminance.

A first variation will be described. When the function button 13 is operated, the EC/KBC 30 notifies the BIOS of a given code irrespective of an external illuminance. Upon reception of the code, the BIOS reads the external illuminance by the illuminance sensor 12 via the EC/KBC 30. When the read value is equal to or higher than a previously-set threshold value, the BIOS returns a code for a bright illuminance (i.e., a code associated with the operation performed on the function button 13 in the state where the ambient environment is “bright”) to the OS. On the other hand, when the external illuminance is lower than the threshold value, the BIOS returns a code for a dark illuminance (i.e., a code associated with the operation performed on the function button 13 in the state where the ambient environment is “dark”) to the OS.

Next, a second variation will be described. When the function button 13 is operated, the EC/KBC 30 and the BIOS notify the OS of a given code irrespective of an external illuminance. Upon reception of the code, the OS reads the external illuminance by the illuminance sensor 12 via the BIOS and the EC/KBC 30. When the read value is equal to or higher than a previously-set threshold value, the OS executes a function for a bright illuminance (i.e., a function associated with the operation performed on the function button 13 in the state where the ambient environment is “bright”). On the other hand, when the read value is lower than the threshold value, the OS executes a function for a dark illuminance (i.e., a function associated with the operation performed on the function button 13 in the state where the ambient environment is “dark”).

Although the function button 13 is exemplified in the present embodiment, the present invention is not limited thereto. For example, the function of the other key and/or button may be changed in accordance with the illuminance of the ambient environment. The function button may be provided in a form of a dial etc.

The embodiment can provide an information processing apparatus capable of changing a function, allocated to a key and/or a button, in accordance with ambient brightness.

The present invention is not limited to the foregoing embodiment but may be modified variously without departing from the scope of the invention.

The embodiments provide an information processing apparatus capable of changing a function, allocated to a key and/or a button, in accordance with ambient brightness.

What is claimed is:

1. An information processing apparatus comprising:
a main body casing;
a display casing connected to the main body casing so as to be rotatable between a closed position at which an upper face of the main body casing is covered, and an open position at which the upper face of the main body casing is uncovered;
an illuminance sensor configured to detect an ambient illuminance around the main body casing;
at least one button provided at the upper face of the main body casing;
a user interface configured to allow the user to enter a function setting in which the ambient illuminance and a function allocated to the button are associated; and
a controller configured to output, when the button is operated, a code for executing a function, based on the ambient illuminance and the function setting.

2. The apparatus of claim 1,
wherein the user interface is configured to allow the user to allocate the button with:
a first function to be executed when a first illuminance is detected by the illuminance sensor; and
a second function to be executed when a second illuminance is detected by the illuminance sensor.

3. The apparatus of claim 2,
wherein the user interface is configured to allow the user to set a reference illuminance serving as a threshold value for determining whether the ambient illuminance detected by the illuminance sensor is to be treated as either the first illuminance or as the second illuminance, which is higher than the first illuminance.

4. The apparatus of claim 3,
wherein the same function is settable as both the first function and the second function.

5. An information processing apparatus comprising:
a main body casing;
a display casing connected to the main body casing so as to be rotatable between a closed position at which an upper face of the main body casing is covered, and an open position at which the upper face of the main body casing is uncovered;
an illuminance sensor configured to detect an ambient illuminance around the illuminance sensor;
at least one button provided at the upper face of the main body casing;
a setting module configured to enter a function setting in which the ambient illuminance and a function allocated to the button are associated; and
a controller configured to execute, when the button is operated, a function, based on the ambient illuminance and the function setting.

6. The apparatus of claim 5,
wherein the setting module is configured to allocate the button with:
a first function to be executed when a first illuminance is detected by the illuminance sensor; and
a second function to be executed when a second illuminance is detected by the illuminance sensor.

7. The apparatus of claim 6,
wherein the setting module is configured to set a reference illuminance serving as a threshold value for determining whether the ambient illuminance detected by the illuminance sensor is to be treated as either the first illuminance or as the second illuminance, which is higher than the first illuminance.

8. The apparatus of claim 7,
wherein the same function is settable as both the first function and the second function.
